(19) United States
(12) Patent Application Publication
(10) Pub. No.: US 2016/0207519 A1
(43) Pub. Date: Jul. 21, 2016

(54) DRIVE CONTROL SYSTEM FOR HYBRID VEHICLE

(71) Applicant: TOYOTA JIDOSHA KABUSHIKI KAISHA, Toyota-shi (JP)

(72) Inventors: Kensei HATA, Shizuoka-ken (JP); Yuji IWASE, Mishima-shi (JP); Yosuke SUZUKI, Hadano-shi (JP); Yota MIZUNO, Nissin-shi (JP); Akiko NISHIMINE, Toyota-shi (JP); Sohei MURATA, Chiryu-shi (JP)

(73) Assignee: TOYOTA JIDOSHA KABUSHIKI KAISHA, Toyota-shi (JP)

(21) Appl. No.: 14/994,432

(22) Filed: Jan. 13, 2016

(30) Foreign Application Priority Data
Jan. 15, 2015 (JP) 2015-005571

(51) Int. Cl. B60W 20/10; B60K 6/44; B60W 30/182; B60K 6/26; B60W 10/08; B60W 10/30

(52) U.S. Cl. CPC B60W 20/10; B60W 10/08; B60W 10/30; B60W 30/182; B60K 6/26; B60K 6/44; B60W 2510/08; B60W 2520/10; B60W 2710/08; B60W 2710/30; Y10S 903/93; Y10S 903/906; B60Y 2200/92

(57) ABSTRACT

A drive control system for a hybrid vehicle comprises a lubricating oil passage, a first oil pump, an electronic control unit, and an electronic control unit. The lubricating oil passage is configured to supply lubricating oil to the power split mechanism by causing the lubricating oil to flow outward in a radial direction of a power split mechanism. The first oil pump is configured to be allowed to be driven by a first motor, and configured to generate hydraulic pressure of the lubricating oil that lubricates the power split mechanism. The electronic control unit is configured to, when the hybrid vehicle is set to a one-motor mode after traveling in a two-motor mode, execute control for increasing an amount of the lubricating oil that is supplied to the power split mechanism by driving the first motor.

### INCORPORATION BY REFERENCE

The disclosure of Japanese Patent Application No. 2015-005571 filed on Jan. 15, 2015 including the specification, drawings and abstract is incorporated herein by reference in its entirety.

### BACKGROUND OF THE INVENTION

1. Field of the Invention

The invention relates to a control system for a hybrid vehicle that uses a motor, which is used in rotation speed control over an engine, as a driving force source that outputs driving force for propelling the hybrid vehicle.

2. Description of Related Art

Japanese Patent Application Publication No. 8-295140 (JP 8-295140 A) describes a so-called two-motor-type hybrid vehicle. The hybrid vehicle includes a power split mechanism formed of a planetary gear mechanism. Torque output from an engine is input to a carrier of the planetary gear mechanism. A first motor that has a power generating function is coupled to a sun gear of the planetary gear mechanism. A ring gear is an output element. The ring gear is coupled to a differential via a counter gear unit that constitutes a speed reduction mechanism. A second motor is coupled to the counter gear unit. Electric power generated by the first motor is allowed to be supplied to the second motor. A brake is provided. The brake stops rotation of an input shaft coupled to the carrier. In a state where the carrier is fixed by engaging the brake, the power split mechanism functions as the speed reduction mechanism, and is able to amplify torque, output from the first motor, and then output the amplified torque from the ring gear. Therefore, in the vehicle described in JP 8-295140 A, three drive modes are allowed to be set. The three drive modes are a hybrid mode (HV mode), a two-motor mode (2 MG mode) and a one-motor mode (1 MG mode). In the HV mode, the engine is used as a driving force source. In the 2 MG mode, the first motor and the second motor are used as driving force sources. In the 1 MG mode, only the second motor is used as a driving force source.

International Application Publication No. 2011/114785 describes a hybrid drive system in which a power split mechanism is formed of a planetary gear mechanism and lubricating oil is supplied to a carrier in the planetary gear mechanism via receivers. The receivers are respectively provided on both end sides of pinion pins, and one of the receivers is oriented radially inward. The carrier on which the pinion pins are provided is coupled to an input shaft that transmits the power of an engine. An oil passage is provided at the axis portion of the input shaft. A rotation transmission shaft including a communication passage is connected to the input shaft. The communication passage supplies pressurized oil produced by an oil pump to the oil passage. The input shaft has discharge passages extending from the oil passage at the axis portion to the outer periphery. Lubricating oil is caused to fly off from the discharge passages by centrifugal force resulting from rotation of the input shaft, and the lubricating oil is trapped by the receiver and guided to the pinion pins.

When the hybrid vehicle described in JP 8-295140 A travels in the 2 MG mode, power output from the first motor is transmitted to the output side via the power split mechanism, so a large load is exerted on the pinion pins and pinion gears that are supported by the carrier. These pinion pins and pinion gears may be lubricated and cooled by oil that flies off from the input shaft side, as described in International Application Publication No. 2011/114785. However, in the 2 MG mode, the rotation of the input shaft is stopped because the engine is stopped, so no centrifugal force that causes oil to fly off is generated. Therefore, there is a possibility that lubrication or cooling of the pinion pins, pinion gears, and the like, is not sufficiently carried out and, as a result, setting of the 2 MG mode is restricted. When the oil pump that generates hydraulic pressure for lubrication is configured to be driven by the engine, the oil pump is not driven in the 2 MG mode, so, in this respect as well, lubrication or cooling of the pinion pins, pinion gears, and the like, may be insufficient.

When the temperature of the pinion pins, pinion gears, and the like, rises to a predetermined temperature or higher as a result of the fact that the vehicle travels in the 2 MG mode, the 2 MG mode is cancelled, and the 2 MG mode is resumed after a decrease in the temperature. However, if the pinion pins, the pinion gears, and the like, are naturally cooled in a state where the engine is stopped as in the case of the 1 MG mode, it takes long time to radiate heat, and the 2 MG mode is not allowed to be set during then, with the result that a period during which the 2 MG mode is not allowed to be set extends. If the 2 MG mode is resumed in a state where the pinion pins, the pinon gears, and the like, are not sufficiently cooled, the temperature of the pinion pins, pinion gears, and the like, rises to the predetermined temperature or higher in a short time after resumption of the 2 MG mode, and the 2 MG mode needs to be cancelled. In this case as well, the period during which the 2 MG mode is not allowed to be set extends. At last, effective use of electric power is restricted even when there is an allowance electric power, and there is a possibility that the fuel economy of the vehicle deteriorates.

### SUMMARY OF THE INVENTION

The invention provides a drive control system that is able to cancel or relieve restrictions on a two-motor mode due to the temperature of a power split mechanism in a hybrid vehicle.

A drive control system related to the present invention is for a hybrid vehicle. The drive control system comprises an engine, an output member, a first motor, a power split mechanism, a lubricating oil passage, a first oil pump, a second motor, and an electronic control unit. The output member is configured to transmit driving force to a drive wheel. The power split mechanism is configured to distribute and transmit driving force, output from the engine, to the output member and the first motor. The lubricating oil passage is configured to supply lubricating oil to the power split mechanism by causing the lubricating oil to flow outward in a radial direction of the power split mechanism from a rotation center side of the power split mechanism. The first oil pump is configured to be allowed to be driven by the first motor. The first oil pump is configured to generate hydraulic pressure of the lubricating oil that lubricates the power split mechanism. The second motor is configured to be able to output driving force to the drive wheel in a state where the engine and the first motor are not generating driving force. The electronic control unit is configured to, when the hybrid vehicle is set to a one-motor mode after traveling in a two-motor mode, execute control for increasing an amount of the lubricating oil that is supplied to the power split mechanism by driving the first motor. The one-motor mode is a mode in which the hybrid vehicle is caused to travel by the use of driving force that is output from the second motor. The two-motor mode is a mode in which the hybrid vehicle is caused to travel by the use of driving force that is output from the first motor and the second motor.

Normally, when the hybrid vehicle travels in the two-motor mode, driving force output from the first motor is transmitted to the output member via the power split mechanism. In this case, because rotation of the engine is stopped, a load or torque that is exerted on the power split mechanism increases, and supply of lubricating oil from the first oil pump stops. On the other hand, in the above-described drive control system, when the one-motor mode in which the second motor outputs driving force is set after the two-motor mode, the first motor that is not outputting driving force for propelling the hybrid vehicle is operated. As a result, the amount of lubricating oil that is supplied to the power split mechanism of which the temperature has risen in the two-motor mode is increased, and the power split mechanism is actively cooled, so it is possible to decrease the temperature of the power split mechanism in a short time.

The electronic control unit may be configured to execute control for increasing the amount of the lubricating oil by driving the first oil pump with the use of the first motor.

The lubricating oil passage may be configured to be rotated to cause the lubricating oil to fly off by centrifugal force. The electronic control unit may be configured to execute control for increasing the amount of the lubricating oil by increasing an amount of the lubricating oil that flies off as a result of rotation of the lubricating oil passage.

With the above-described drive control system, the amount of lubricating oil that is supplied to the power split mechanism is increased by increasing the pump discharge capacity or increasing the centrifugal force.

The drive control system may further comprise a second oil pump. The second oil pump is configured to supply the lubricating oil to the power split mechanism via the lubricating oil passage by generating hydraulic pressure of the lubricating oil. The electronic control unit may be configured to, when the hybrid vehicle is set to the one-motor mode after traveling in the two-motor mode and when the amount of lubricating oil discharged from the second oil pump is larger than or equal to a predetermined threshold, not drive the first oil pump with the use of the first motor.

With the above-described drive control system, when the amount of lubricating oil that is supplied from the second oil pump is larger than or equal to the predetermined threshold, driving of the first oil pump with the use of the first motor is stopped, so unnecessary or excessive driving of the first motor is avoided or suppressed.

The electronic control unit may be configured to, when the hybrid vehicle is set to the one-motor mode after traveling in the two-motor mode and when a vehicle speed is lower than or equal to a predetermined vehicle speed, execute control for increasing the amount of the lubricating oil by driving the first oil pump with the use of the first motor.

With the above-described drive control system, in a state where the vehicle speed is lower than or equal to the predetermined vehicle speed, the first oil pump is driven with the use of the first motor in the one-motor mode. Therefore, when the amount of lubricating oil that is dipped by the power split mechanism or a predetermined rotary member is small, lubricating oil is actively supplied from the first oil pump to the power split mechanism, so the power split mechanism is sufficiently cooled and lubricated. In other words, when the amount of lubricating oil dipped is sufficient because of a high vehicle speed, driving of the first motor for supplying lubricating oil is stopped, so unnecessary or excessive driving of the first motor is avoided or suppressed.

The drive control system may further comprises an input shaft. The input shaft may be coupled to an output shaft of the engine. The input shaft may be configured to transmit driving force of the engine to the power split mechanism. The brake mechanism may be configured to stop rotation of the output shaft or rotation of the input shaft. The transmission shaft may couple the input shaft to the first oil pump. The transmission shaft and the input shaft may have the lubricating oil passage, and the input shaft may have an opening at its outer periphery. The lubricating oil passage may extend in an axial direction and is coupled to the opening. The lubricating oil passage may be configured to cause lubricating oil to fly off toward the power split mechanism by rotating the input shaft with the use of the first motor.

With the above-described drive control system, by driving the first motor for supplying lubricating oil in the one-motor mode, the input shaft is rotated together with the engine. As the input shaft rotates, lubricating oil is caused to fly off from the lubricating oil passage by centrifugal force, so it is possible to actively supply lubricating oil toward the power split mechanism.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a flowchart for illustrating a first embodiment of control that is executed in a drive control system according to the invention;

FIG. 2 is a flowchart for illustrating a second embodiment of control that is executed in the drive control system according to the invention;

FIG. 3 is a flowchart for illustrating a third embodiment of control that is executed in the drive control system according to the invention;

FIG. 4 is a flowchart for illustrating a fourth embodiment of control that is executed in the drive control system according to the invention;

FIG. 5 is a flowchart for illustrating a fifth embodiment of control that is executed in the drive control system according to the invention;

FIG. 6 is a flowchart for illustrating a sixth embodiment of control that is executed in the drive control system according to the invention;

FIG. 7 is a skeletal view that shows a first example of a powertrain in a hybrid vehicle to which the invention is applicable;

FIG. 8 is a partially cross-sectional view that specifically shows a portion at which an output shaft of an engine is coupled to a carrier;

FIG. 9 is a graph that shows an example of regions of an HV mode, a two-motor mode and a one-motor mode;

FIG. 10 is a skeletal view that shows a second example of the powertrain in the hybrid vehicle to which the drive control system according to the invention is applicable;

FIG. 11 is a skeletal view that shows a third example of the powertrain in the hybrid vehicle to which the drive control system according to the invention is applicable;

FIG. 12 is a skeletal view that shows a fourth example of the powertrain in the hybrid vehicle to which the drive control system according to the invention is applicable;

FIG. 13 is a skeletal view that shows a fifth example of the powertrain in the hybrid vehicle to which the drive control system according to the invention is applicable; and

FIG. 14 is a skeletal view that shows a sixth example of the powertrain in the hybrid vehicle to which the drive control system according to the invention is applicable.

### DETAILED DESCRIPTION OF EMBODIMENTS

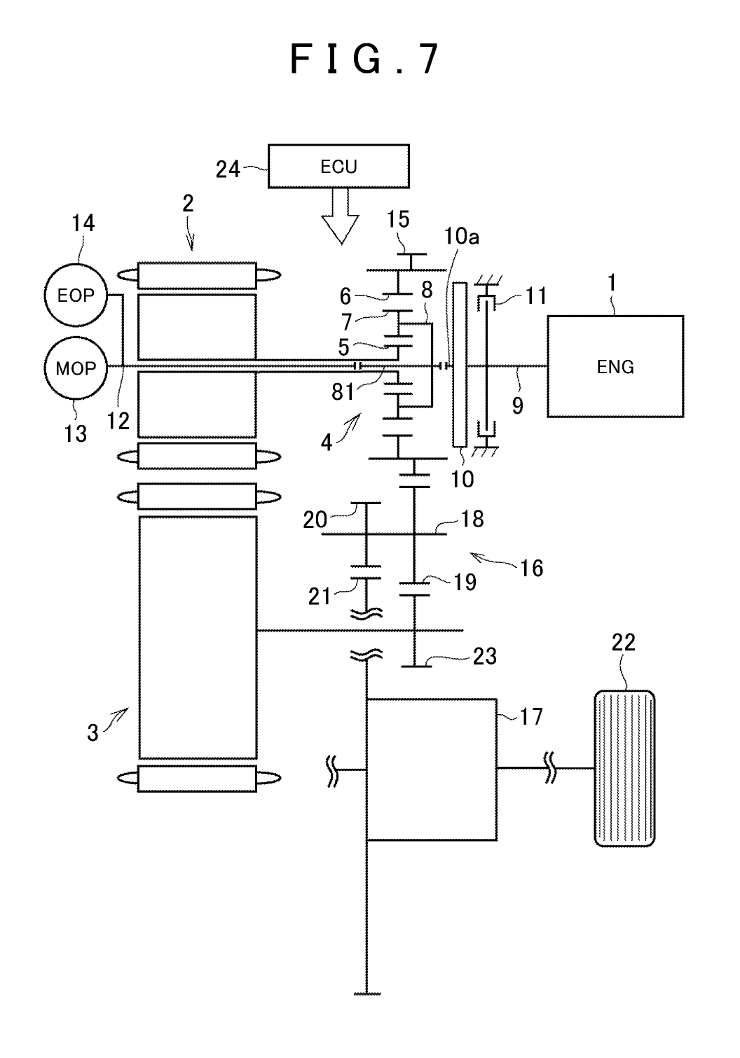

An example of a hybrid vehicle to which the invention is applicable is shown by a skeletal view in FIG. 7. A hybrid drive system is a so-called two-motor-type drive system, and includes an engine (ENG) 1 and two motors 2, 3 as driving force sources. The engine 1 is an internal combustion engine, such as a gasoline engine and a diesel engine. The first motor 2 may be a motor generator (MG) that is able to regenerate energy or output power. The second motor 3 may be similarly a motor generate (MG). The hybrid drive system includes a power split mechanism 4 that distributes power, output from the engine 1, to the first motor 2 and an output member. The power split mechanism 4 may be formed of a differential mechanism, such as a planetary gear mechanism, and is formed of a single-pinion-type planetary gear mechanism in the example shown in FIG. 7.

A plurality of (for example, three) pinion gears 7 that are in mesh with a sun gear 5 and a ring gear 6 are arranged between these sun gear 5 and ring gear 6. Those pinion gears 7 are supported by a carrier 8 so as to be rotatable and revolvable. A structure of supporting the pinion gears 7 by the carrier 8 is similar to a structure in a generally known planetary gear mechanism. The structure will be simply described. Pinion pins are supported by the carrier 8, and each of the pinion gears 7 is rotatably fitted to the outer peripheral side of a corresponding one of the pinion pins via a bearing, such as a needle bearing. Each of the pinion pins has an oil hole along its central axis. Another oil hole extends from each oil hole to the outer periphery. Lubricating oil is supplied to the bearings and the tooth flanks via these oil holes.

The carrier 8 is a so-called input element. Power from the engine 1 is transmitted to the carrier 8. That is, an output shaft (crankshaft) 9 of the engine 1 and the carrier 8 are coupled to each other via a damper mechanism 10. A brake mechanism 11 is provided between the carrier 8 and the engine 1. The brake mechanism 11 selectively stops rotation of the carrier 8. The brake mechanism 11 may be any one of a friction brake, a dog brake and a one-way clutch.

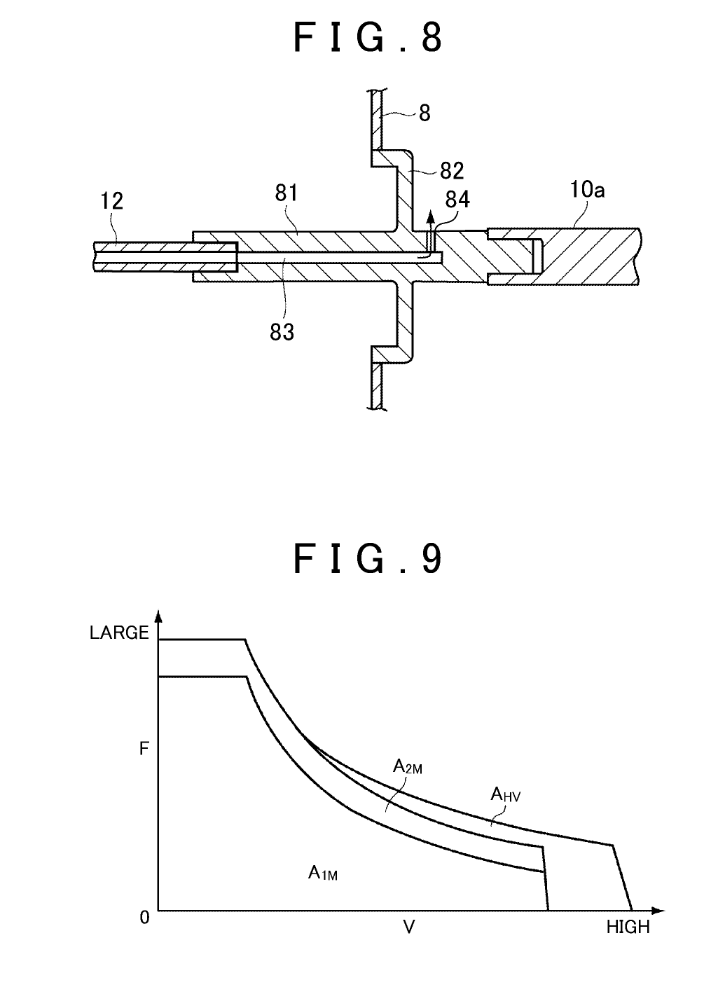

FIG. 8 is a view that further specifically shows a portion at which the output shaft 9 of the engine 1 is coupled to the carrier 8. An input shaft 81 is coupled to the distal end portion of an output shaft 10a of the damper mechanism 10. A flange portion 82 is integrated with the outer peripheral portion of the input shaft 81, and the carrier 8 is coupled to the outer peripheral end of the flange portion 82. A lubricating oil passage 83 extends along the axis from an end of the input shaft 81 across from the output shaft 10a. The lubricating oil passage 83 extends beyond the flange portion 82 to the output shaft 10a side, bends radially outward from its end, and then opens at the outer periphery of the input shaft 81. Therefore, the lubricating oil passage 83 is arranged at the center side of the power split mechanism 4. In addition, a pump shaft 12 that is a hollow shaft is arranged along the same axis as the input shaft 81. The pump shaft 12 is an example of a transmission shaft in the embodiment of the invention, and is used to transmit power to an oil pump 13 (described later). A hollow portion along the axis of the pump shaft 12 constitutes the lubricating oil passage 83.

The first motor 2 is arranged along the same axis as the power split mechanism 4 across the power split mechanism 4 from the engine 1. The first motor 2 is coupled to the sun gear 5. Therefore, the sun gear 5 is a so-called reaction element. A rotor shaft of the first motor 2 and a sun gear shaft to which the rotor shaft is coupled are hollow shafts. The pump shaft 12 is inserted inside the hollow shafts. One end of the pump shaft 12 is coupled to the output shaft 9 of the engine 1 via the input shaft 81 as described above. An oil pump (mechanical oil pump (MOP)) 13 is coupled to the other end of the pump shaft 12. The MOP 13 is driven by the engine 1 to generate hydraulic pressure for control and hydraulic pressure for lubrication. Therefore, a second oil pump (electric oil pump (EOP)) 14 is provided in parallel with the MOP 13. The second oil pump 14 is driven by a motor in order to ensure hydraulic pressure at the time when the engine 1 is stopped.

The ring gear 6 in the planetary gear mechanism that constitutes the power split mechanism 4 is a so-called output element. An output gear 15 that is an external gear is integrally provided with the ring gear 6. The output gear 15 is coupled to a differential gear 17 via a counter gear unit 16. That is, a driven gear 19 connected to a counter shaft 18 is in mesh with the output gear 15. A drive gear 20 having a smaller diameter than the driven gear 19 is connected to the counter shaft 18. The drive gear 20 is in mesh with a ring gear 21 in the differential gear 17. A driving force is output from the differential gear 17 to right and left drive wheels 22. Another drive gear 23 is in mesh with the driven gear 19. The second motor 3 is coupled to the drive gear 23. That is, torque of the second motor 3 is added to torque that is output from the output gear 15. The drive gear 20 is an example of an output member in the embodiment of the invention. The first motor 2 and the second motor 3 are electrically connected to each other via an electrical storage device (not shown) or an inverter (not shown), and are configured to be able to supply electric power generated by the first motor 2 to the second motor 3.

The above-described hybrid vehicle is allowed to be selectively set to any one of three drive modes, that is, a hybrid mode (HV mode), a two-motor mode (hereinafter, referred to as 2 MG mode) and a one-motor mode (hereinafter, referred to as 1 MG mode). The HV mode is a drive mode in which power output from the engine 1 is distributed by the power split mechanism 4 to the first motor 2 side and the output gear 15 side, electric power generated by the first motor 2 functioning as a power generator is supplied to the second motor 3, and the output torque of the second motor 3 is added to the torque of the output gear 15 in the counter gear unit 16. The 2 MG mode is a mode in which the first motor 2 and the second motor 3 are operated as driving force sources for propelling the hybrid vehicle, and the hybrid vehicle travels by the use of the power of these two motors 2, 3. In this case, the output shaft 9 and the carrier 8 are fixed by the brake mechanism 11. Therefore, the power split mechanism 4 functions as a speed reduction mechanism between the first motor 2 and the output gear 15. The 1 MG mode is a mode in which the hybrid vehicle travels by using the second motor 3 as a driving force source.

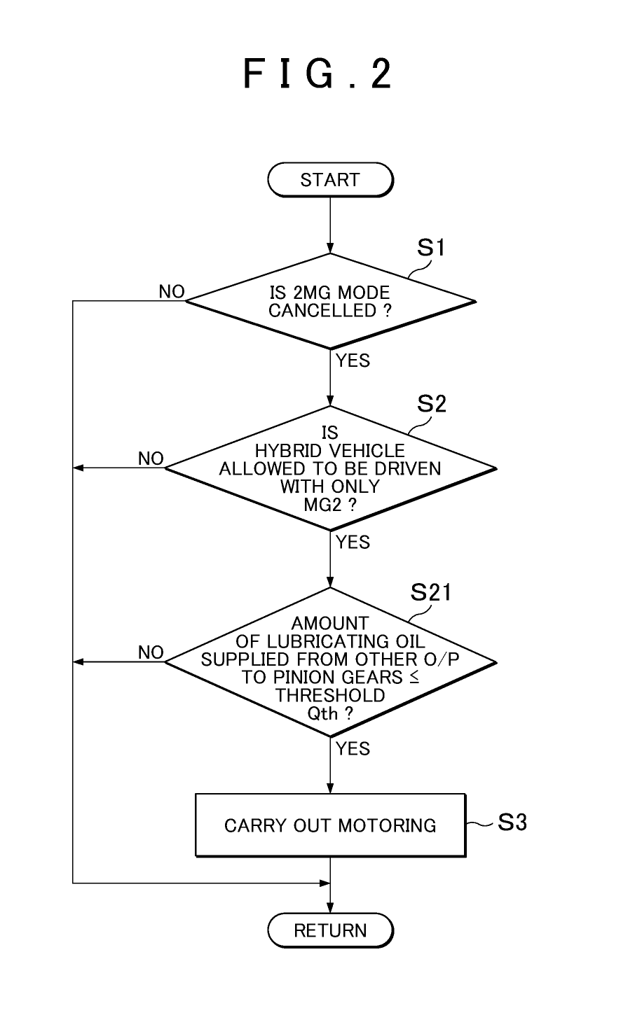

Driving torque, fuel economy, and the like, are different from one another among these drive modes, so regions of those drive modes are determined by a vehicle speed, a driving force, and the like, and the drive mode is selected on the basis of a required driving force, represented by an accelerator position, and a vehicle speed. FIG. 9 shows the regions of the drive modes, determined in advance by a vehicle speed V and a driving force F. In FIG. 9, the region indicated by the sign AHV is the HV mode region, the region indicated by the sign A2M is the 2 MG mode region, and the region indicated by the sign AIM is the 1 MG mode region. An electronic control unit (ECU) 24 is provided as a controller for selecting any one of these drive modes and controlling the units of the hybrid drive system such that the selected drive mode is established. The ECU 24 is mainly formed of a microcomputer. The ECU 24 is configured to perform a computation on the basis of input data and data, such as a prestored map, and output the computed result as a control command signal to the engine 1, each of the motors 2, 3, the electrical storage device or the inverter for the motors 2, 3, the brake mechanism 11, or the like. Examples of data that are input to the ECU 24, that is, data that are used in control, include the vehicle speed, the accelerator position, the rotation speeds of the motors 2, 3, the driving currents of the motors 2, 3, the temperature (oil temperature) of lubricating oil), the on/off state of an ignition switch of the hybrid vehicle, the temperature (ambient temperature) of an environment in which the hybrid vehicle is placed, and the like. The above-described regions shown in FIG. 2, the rate of rise and rate of decrease in the temperature of the pinion gears, pinion pins, or the like, the initial value of the temperature, determination thresholds for time and temperature, and the like, are stored in advance.

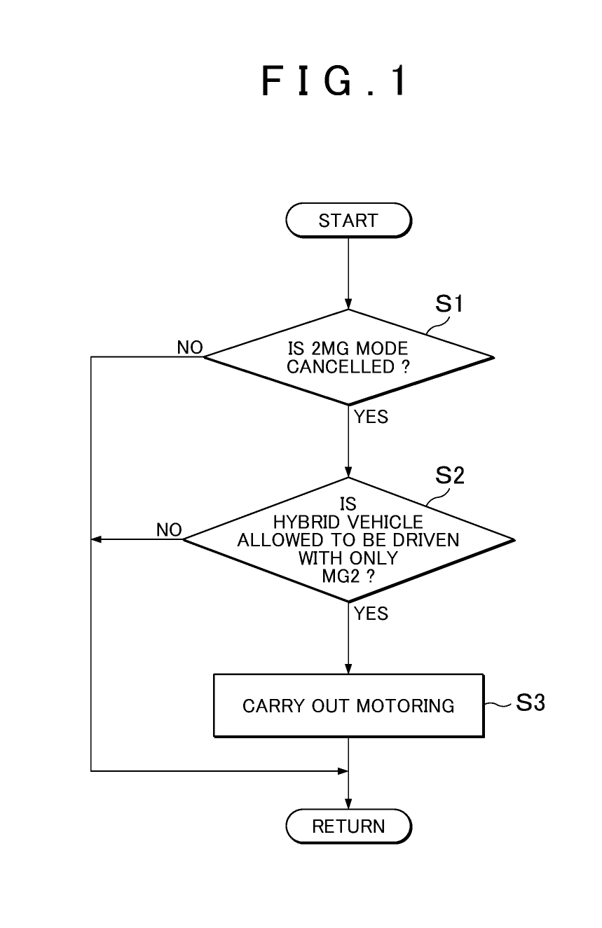

When the above-described hybrid vehicle travels in the 2 MG mode, not only the second motor 3 outputs driving force but also the first motor 2 rotates in a negative direction (a direction opposite to the normal rotation direction of the engine 1) in a state where the output shaft 9 and the carrier 8 are fixed by the brake mechanism 11 to output driving force. Therefore, a large load (torque) is exerted on the power split mechanism 4 (particularly, the pinion gears 7 and the pinion pins). Because the carrier 8 is not rotating, the amount of lubricating oil supplied reduces as compared to the case where the hybrid vehicle is traveling in the HV mode. In the 2 MG mode, the temperature of the power split mechanism 4 tends to rise because of such factors, that is, an increase in load, a reduction in the amount of lubricating oil, or the like, and, when the temperature or the temperature of lubricating oil reaches an upper limit temperature determined by design, the 2 MG mode is prohibited. The drive control system according to the invention is configured to actively cool the power split mechanism 4 of which the temperature has risen in this way. An example of the control is shown by the flowchart in FIG. 1

The control shown in the flowchart is executed by the above-described ECU 24 when the hybrid vehicle is traveling or the 2 MG mode is set. Initially, it is determined whether the 2 MG mode is cancelled (step S1). This determination may be made on the basis of the vehicle speed, the required driving force and the map shown in FIG. 9 or may be made on the basis of control signals to the motors 2, 3. When negative determination is made in step S 1, the process returns without any particular control. In contrast, when affirmative determination is made in step S1, it is determined whether it is allowed to drive the hybrid vehicle with the use of only the second motor 3 (MG2) (step S2). This determination may be made on the basis of the traveling state of the hybrid vehicle, such as the required driving force and the vehicle speed. For example, negative determination is made when the traveling state falls within the HV mode region AHV shown in FIG. 9; whereas affirmative determination is made in step S2 when the traveling state falls within the 1 MG mode region MM. Therefore, in step S2, it may be determined whether it is the state where the 1 MG mode is set.

When negative determination is made is step S2, the process returns without any particular control. In contrast, when affirmative determination is made in step S2, motoring is carried out (step S3), and then the process returns. Motoring is to rotate the engine 1 by using external force and, more specifically, is to rotate the output shaft 9 of the engine 1 in the forward direction (rotate the engine 1 in the normal direction of the engine 1) with the use of the first motor 2. The motoring may be carried out just after the 2 MG mode is cancelled and the 1 MG mode is set or at the instance when the 1 MG mode is set or may be carried out after a lapse of a predetermined time from when the 1 MG mode is set. In short, the motoring just needs to be carried out in a state where the 1 MG mode is set.

The 1 MG mode is a drive mode in which the second motor 3 is used as a driving force source, and the first motor 2 is not used as a driving force source for propelling the hybrid vehicle, so the first motor 2 is allowed to be stopped or driven where necessary. When the first motor 2 is rotated in the forward direction in a state where fixing of the output shaft 9 by the above-described brake mechanism 11 is released, reaction torque in a direction to stop the rotation of the ring gear 6 is exerted on the ring gear 6 in the power split mechanism 4, so torque in the forward rotation direction acts on the carrier 8 and the output shaft 9 coupled to the carrier 8. Therefore, the output shaft 9 and the input shaft 81 and pump shaft 12 coupled to the output shaft 9 are rotated, and the MOP 13 is driven accordingly to generate hydraulic pressure.

At least part of hydraulic pressure generated in the MOP 13 is transferred through the lubricating oil passage 83 to the outer periphery of the input shaft 81. When the hydraulic pressure is sufficiently high, lubricating oil is injected from an opening 84 of the lubricating oil passage 83 toward the power split mechanism 4. Centrifugal force acts on lubricating oil because of rotation of the input shaft 81, and lubricating oil is caused to fly off outward in the radial direction of the input shaft 81, that is, toward the power split mechanism 4, by the centrifugal force. Lubricating oil is actively supplied from the MOP 13 toward the power split mechanism 4 (particularly, the pinion gears 7 and the pinion pins) that has risen in temperature in the 2 MG mode and that is not associated with generation of driving force for propelling the hybrid vehicle in the 1 MG mode. Because the lubricating oil removes heat from the power split mechanism 4, the power split mechanism 4 is actively cooled. In this case, when a condition that the state of charge (SOC) in the electrical storage device is sufficient, or the like, is satisfied, the EOP 14 may be driven together to increase the amount of oil.

As described above, in the drive control system according to the invention, when the drive mode changes from the 2 MG mode, in which the temperature of the power split mechanism 4 tends to rise, to the 1 MG mode, the MOP 13 is driven by the first motor 2, which is not used to generate driving force, to generate hydraulic pressure for lubrication. Because the thus pressurized lubricating oil is supplied to the power split mechanism 4, the power split mechanism 4 is promptly cooled, and the temperature of the power split mechanism 4 decreases. Therefore, because the condition that restrains setting of the 2 MG mode in terms of temperature is early resolved, the 2 MG mode is allowed to be set immediately when the hybrid vehicle enters the traveling state based on which the 2 MG mode should be set, and a time until the temperature of the power split mechanism 4 in the resumed 2 MG mode reaches a predetermined upper limit temperature extends. In any case, a period during which the 2 MG mode is allowed to be set extends and, by extension, electric power is effectively utilized, so it is possible to improve the fuel economy of the hybrid vehicle.

The invention is applicable to a drive control system for a hybrid vehicle including not only the above-described MOP 13 but also the EOP 14 or a hybrid vehicle including further another oil pump (not shown). Hydraulic pressure discharged from the other oil pump is allowed to be supplied from the above-described lubricating oil passage 83 toward the power split mechanism 4. In this case, unless the input shaft 81 is rotating, it is not possible to supply lubricating oil by utilizing centrifugal force. However, it is possible to rotate the carrier 8 because of rotation of the ring gear 6 in the 1 MG mode, so, even when lubricating oil does not fly off by centrifugal force, it is possible to sufficiently supply lubricating oil, flowing out from the lubricating oil passage 83, to the pinion gears 7 and the pinion pins. A control example shown in FIG. 2 is an example configured to carry out motoring in consideration of the amount of lubricating oil, which is supplied by such another oil pump.

Specifically, the control example shown in FIG. 2 is an example in which a step of determining the amount of lubricating oil that is supplied by another oil pump is added to the above-described control example shown in FIG. 1. Therefore, like step numbers denote the same steps as the control steps shown in FIG. 1, and the description thereof is omitted. In FIG. 2, when affirmative determination is made in step S2, it is determined whether the amount of lubricating oil that is supplied from the other oil pump, such as the EOP 14, to the pinion gears 7, and the like, is smaller than or equal to a predetermined threshold Qth (step S21). The amount of lubricating oil that is supplied to the pinion gears 7, and the like, which is determined here, may be not a directly measured amount but an amount obtained from the discharge capacity of the other oil pump, the rotation speed of the other oil pump, and the like. The threshold Qth may be determined in advance on the basis of a cooling amount of heat, which is a design target. The threshold Qth may be a constant value or may be a variable that changes with the temperature of lubricating oil.

When negative determination is made in step S21, that is, when the amount of lubricating oil that is supplied by the other oil pump is larger than the threshold Qth, the process returns without any particular control. That is, motoring using the first motor 2 is not carried out. In contrast, when affirmative determination is made in step S21, that is, when the amount of lubricating oil that is supplied by the other oil pump is smaller than or equal to the threshold Qth, motoring using the first motor 2 is carried out in order to compensate for an insufficient amount of lubricating oil (step S3).

With the configuration that executes the control shown in FIG. 2, when the amount of lubricating oil that is supplied by the other oil pump is sufficiently ensured, it is possible to sufficiently cool the power split mechanism 4 (particularly, the pinion gears 7 and the pinion pins), and, at the same time, it is possible to avoid or suppress unnecessary or excessive driving of the first motor 2.

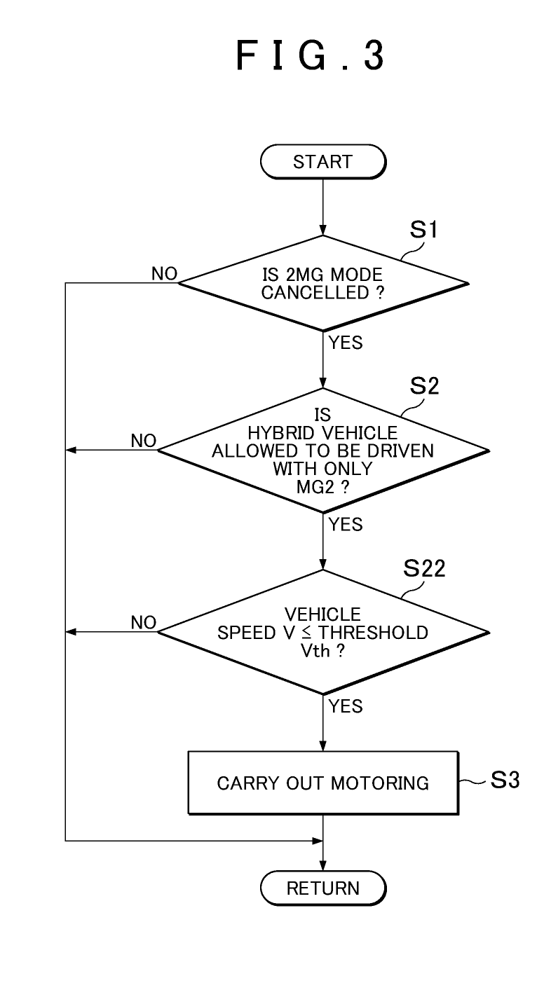

Lubricating oil may be supplied to the power split mechanism 4 not with the use of the MOP 13, the EOP 14 or the other oil pump. For example, the lower portion of the ring gear 6 in the planetary gear mechanism that constitutes the power split mechanism 4 or the lower portion of the differential gear 17 may be immersed in lubricating oil in an oil reservoir. In such a case, rotary members, such as the ring gear 6 and the differential gear 17, rotate to dip lubricating oil, and the lubricating oil flows down toward the pinion gears 7 and the pinion pins to lubricate or cool the pinion gears 7 and the pinion pins. When such so-called dipping lubrication is sufficiently carried out, supplying lubricating oil by driving the first motor 2 may be restricted. An example shown in FIG. 3 is an example configured to carry out motoring in consideration of the amount of lubricating oil resulting from such so-called dipping lubrication.

Specifically, the control example shown in FIG. 3 is an example in which a step of determining a vehicle speed is added to the above-described control example in FIG. 1. Therefore, like step numbers denote the same steps as the control steps shown in FIG. 1, and the description thereof is omitted. In FIG. 3, when affirmative determination is made in step S2, it is determined whether the vehicle speed V is lower than or equal to a predetermined threshold Vth for vehicle speed (step S22). When the vehicle speed V in the 1 MG mode is a high vehicle speed, the rotation speed of the ring gear 6 is a high rotation speed, the amount of lubricating oil that is dipped (the amount of lubricating oil that is supplied) by the rotary members, such as the ring gear 6 and the differential gear 17, increases. When the vehicle speed V is a low vehicle speed, the amount of lubricating oil that is dipped (the amount of lubricating oil that is supplied) by the rotary members, such as the ring gear 6 and the differential gear 17, reduces. Therefore, in step S22, substantially, it is determined whether the amount of dipping lubrication is large or small.

When negative determination is made in step S22, that is, when the vehicle speed V is higher than the threshold Vth, the process returns without any particular control. That is, motoring using the first motor 2 is not carried out. This is because the amount of lubricating oil that is dipped by the rotary members, such as the ring gear 6 and the differential gear 17, is sufficient to lubricate and cool the power split mechanism 4. In contrast, when affirmative determination is made in step S22, that is, when the vehicle speed V is lower than or equal to the threshold Vth and the amount of lubricating oil that is dipped by the rotary members, such as the ring gear 6 and the differential gear 17, is insufficient, motoring using the first motor 2 is carried out in order to compensate for the insufficient amount of lubricating oil (step S3).

With the configuration that executes the control shown in FIG. 3, when the amount of lubricating oil that is dipped by the rotary members, such as the ring gear 6, is small because of a low vehicle speed, it is possible to sufficiently increase the amount of lubricating oil by driving the MOP 13 with the use of the first motor 2, so it is possible to sufficiently cool the power split mechanism 4 (particularly, the pinion gears 7 and the pinion pins). When the amount of lubricating oil dipped is sufficiently large because of a high vehicle speed, it is possible to sufficiently cool the power split mechanism 4, and, at the same time, it is possible to avoid or suppress unnecessary or excessive driving of the first motor 2.

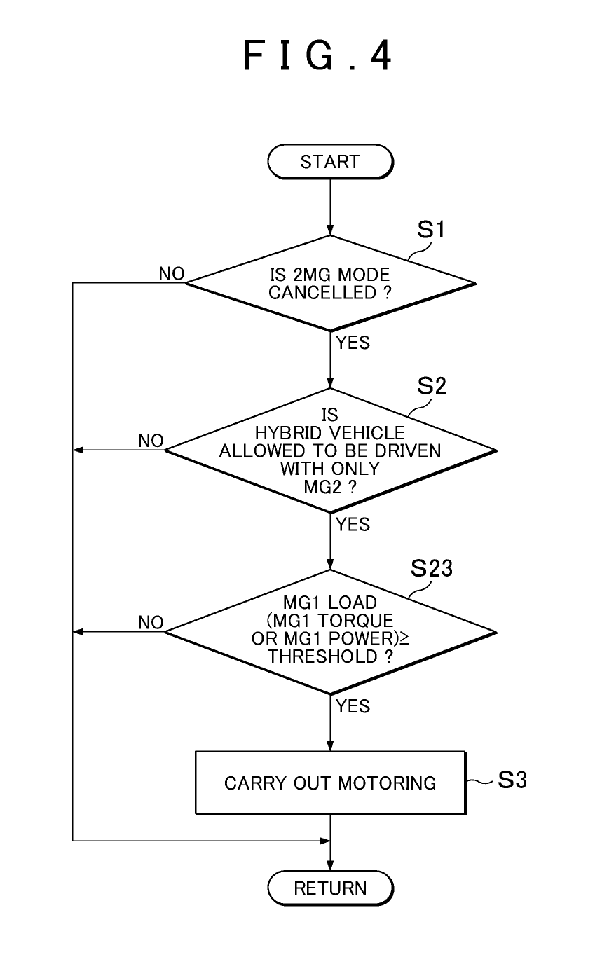

Control for increasing the amount of lubricating oil by driving the MOP 13 with the use of the first motor 2 is executed in order to decrease the temperature of the power split mechanism 4 that has risen in temperature in the 2 MG mode. Therefore, when it is presumed that the temperature of the power split mechanism 4 has not particularly risen, control for driving the MOP 13 with the use of the first motor 2 does not need to be executed in the 1 MG mode. FIG. 4 is an example configured to determine a rise in the temperature of the power split mechanism 4 in the 2 MG mode just before the drive mode switches to the 1 MG mode on the basis of the load of the first motor 2 and determine whether to carry out motoring in response to the determined result.

Specifically, the control example shown in FIG. 4 is an example in which a step of determining the load of the first motor 2, corresponding to the amount of heat generated or a rise in the temperature in the power split mechanism 4, to the above-described control example shown in FIG. 1. Therefore, like step numbers denote the same steps as the control steps shown in FIG. 1, and the description thereof is omitted. In FIG. 4, when affirmative determination is made in step S2, it is determined whether the load of the first motor 2 (MG1) in the 2 MG mode that has been set just before the drive mode is changed to the 1 MG mode is larger than or equal to a predetermined threshold for the load (step S23). The load of the first motor 2 is the torque of the first motor 2, the power of the first motor 2 or the rotation speed of each pinion gear 7 or a value that is calculated on the basis of any one of these. In step S23, it is determined whether a detected value or a calculated value is larger than or equal to a threshold provided in advance in correspondence with any one of them. The threshold may be determined in advance by an experiment, simulation, or the like, as, for example, a value at which the temperature of the power split mechanism 4 (particularly, the pinion gears 7 and the pinion pins) becomes a temperature at which active cooling is required.

When the load of the first motor 2 in the 2 MG mode is smaller than the threshold, the temperature of the power split mechanism 4 is low; whereas, when the load of the first motor 2 is larger than or equal to the threshold, the temperature of the power split mechanism 4 is high. Therefore, in step S23, substantially, the temperature of the power split mechanism 4 at the time when the 2 MG mode is terminated or at the time when the drive mode switches to the 1 MG mode.

When negative determination is made in step S23, that is, when the load of the first motor 2 is smaller than the threshold, the process returns without any particular control. That is, motoring using the first motor 2 is not carried out. This is because the temperature of the power split mechanism 4 is not particularly high and it is presumably not particularly required to actively cool the power split mechanism 4. In contrast, when affirmative determination is made in step S23, that is, when the load of the first motor 2 is larger than or equal to the threshold, motoring using the first motor 2 is carried out in order to actively cool the power split mechanism 4 (step S3).

With the configuration that executes the control shown in FIG. 4, it is possible to select whether to drive the MOP 13 with the use of the first motor 2 in response to the temperature of the power split mechanism 4. As a result, it is possible to promptly cool the power split mechanism 4, and it is possible to avoid or suppress unnecessary or excessive driving of the first motor 2.

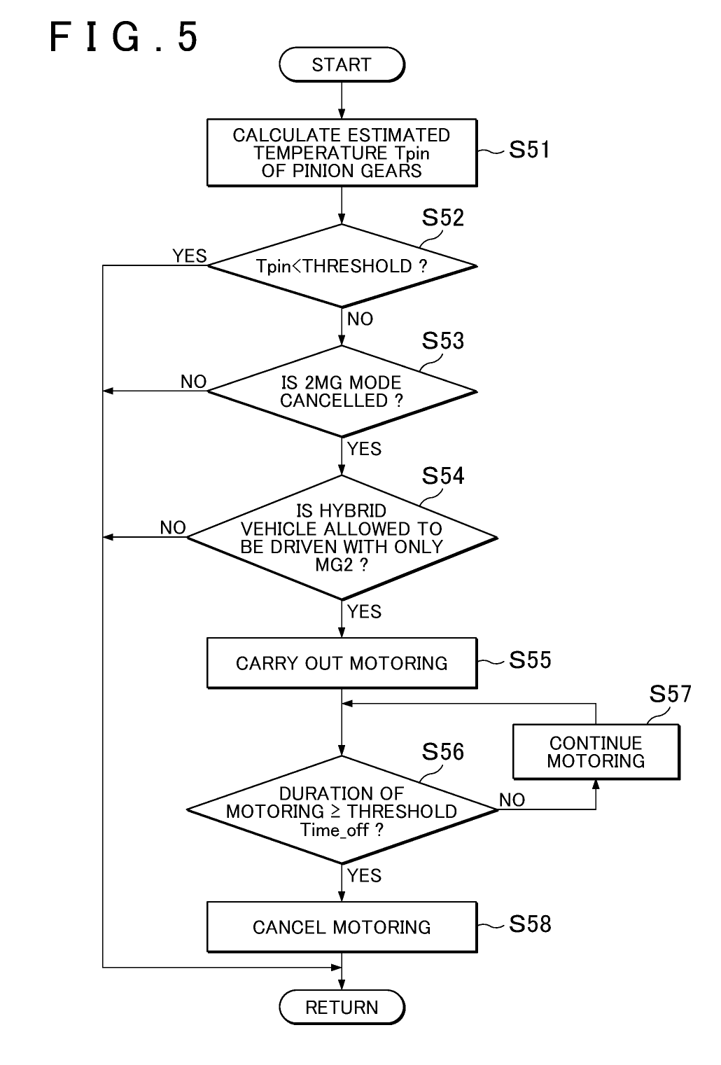

As already described above, each drive mode is selected in response to a traveling state that is determined by a vehicle speed, a required driving force, and the like, so a change of the drive mode from the 2 MG mode to the 1 MG mode occurs because of a change of the traveling state. In the 2 MG mode, the first motor 2 operates to output driving force for propelling the hybrid vehicle, a load is exerted on the power split mechanism 4, and the temperature of the power split mechanism 4 tends to rise. In such a case as well, the drive mode can be changed from the 2 MG mode to the 1 MG mode. This is to protect the device or maintain the durability. A control example in the case where the drive mode is changed to the 1 MG mode because of such a temperature is shown in FIG. 5.

In the control example shown in FIG. 5, initially, an estimated temperature Tpin of the pinion gears 7 (or the power split mechanism 4) is calculated (step S51). The estimated temperature Tpin may be calculated by various methods as needed. For example, the relationship between the duration of the 2 MG mode, the integrated load of the first motor 2, or the like, and the temperature of the power split mechanism 4 is obtained in advance by an experiment, simulation, or the like, and then the estimated temperature Tpin of the power split mechanism 4 may be calculated on the basis of the relationship and an actual operating state in the 2 MG mode.

In step S52, it is determined whether the estimated temperature Tpin is lower than a predetermined threshold. The threshold is an upper limit temperature at or below which the 2 MG mode is allowed to be executed, and is determined by design in consideration of the durability of the power split mechanism 4, or the like. When affirmative determination is made in step S52, it is allowed to continue the 2 MG mode, so the process returns without starting any new control. In contrast, when negative determination is made in step S52, it is determined whether the 2 MG mode is cancelled (step S53). Step S53 is to determine whether a 2 MG mode cancellation condition other than a temperature is satisfied, and the 2 MG mode cancellation condition is, for example, a vehicle speed, a required driving amount such as an accelerator position, or the like. When negative determination is made in step S53, the process returns without any particular control. In contrast, when affirmative determination is made in step S53, it is determined whether it is possible to drive the hybrid vehicle with the use of only the second motor 3 (MG2) (step S54). This determination is a similar determination to that of the above-described step S2 shown in FIG. 1. Therefore, when negative determination is made in step S54, the process returns without any particular control. When affirmative determination is made in step S54, motoring is carried out (step S55). The control in step S55 is similar to the control in the above-described step S3 in FIG. 1. The first motor 2 is driven in a state where the brake mechanism 11 is controlled to a released state, and the engine 1 and the input shaft 81, pump shaft 12 and MOP 13 coupled to the engine 1 are rotated. Therefore, lubricating oil is actively supplied to the power split mechanism 4, and the power split mechanism 4 is cooled.

Subsequently, it is determined whether the duration of motoring is longer than or equal to a threshold Time_off for the motoring (step S56). The duration of motoring may be measured by starting counting at the instance when motoring is carried out in step S55. The threshold Time_off is a time that is required for the temperature of the power split mechanism 4 that is cooled as a result of motoring in step S56 becomes lower than or equal to a predetermined reference temperature, and may be obtained in advance by an experiment, simulation, or the like. Because the degree of cooling the power split mechanism 4 is influenced by an ambient temperature, the temperature of lubricating oil, and the like, the reference temperature may be a variable that changes with these temperatures.

When negative determination is made in step S56, it means that the temperature of the power split mechanism 4 (particularly, the pinion gears 7 and the pinion pins) has not sufficiently decreased yet, so motoring is continued (step S57), and the process returns to step S56. In contrast, when affirmative determination is made in step S56, it means that the temperature of the power split mechanism 4 (particularly, the pinion gears 7 and the pinion pins) has decreased to the reference temperature or below, so motoring is cancelled (stopped) (step S58). At the instance when motoring is cancelled, counting of the duration of motoring is stopped, and the counted value is reset to zero.

With the configuration that executes the control shown in FIG. 5, active cooling of the power split mechanism 4 with the use of the first motor 2 is carried out in response to the temperature of the power split mechanism 4, so it is possible to not only maintain the durability of the device, such as the power split mechanism 4, but also promptly resume the 2 MG mode after cancellation of the 2 MG mode, and it is also possible to extend the duration of the 2 MG mode by delaying a time until the temperature of the power split mechanism 4 reaches the upper limit value in the resumed 2 MG mode. Driving of the MOP 13 with the use of the first motor 2 is not unnecessarily continued, so it is possible to effectively utilize electric power or energy.

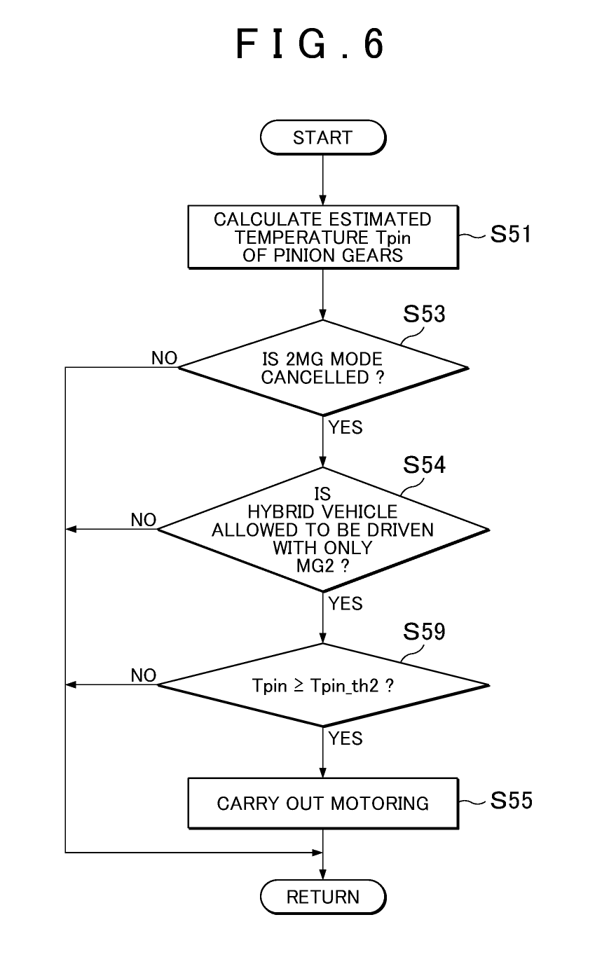

When the temperature of the power split mechanism 4, such as the temperature of the pinion gears 7 and pinion pins, is configured to be estimated, the above-described motoring may be carried out or not carried out on the basis of the estimated temperature Tpin. FIG. 6 shows such a control example. The control example shown in FIG. 6 is partially modified from the above-described control example shown in FIG. 5. Therefore, like step numbers denote the same steps as the control steps shown in FIG. 5, and the description thereof is omitted. In FIG. 6, when negative determination is made in step S54, the process returns without any particular control. In contrast, when affirmative determination is made in step S54, it is determined whether the estimated temperature Tpin is higher than or equal to an upper limit value Tpin_th2 for the temperature of the power split mechanism 4 (particularly, the pinion gears 7 and the pinion pins) (step S59). The upper limit value Tpin_th2 may be determined in advance in consideration of the strength or durability of the power split mechanism 4, a degradation temperature of lubricating oil, or the like.

When negative determination is made in step S59 as a result of the fact that the estimated temperature Tpin has not reached the upper limit value Tpin_th2, the process returns without any particular control. In contrast, when affirmative determination is made in step S59 as a result of the fact that the estimated temperature Tpin is higher than or equal to the upper limit value Tpin th2, motoring is carried out (step S55). Therefore, with the configuration that executes the control shown in FIG. 6, as in the case of the configuration that executes the above-described control shown in FIG. 5, it is possible to not only maintain the durability of the device, such as the power split mechanism 4, but also promptly resume the 2 MG mode after cancellation of the 2 MG mode, and it is also possible to extend the duration of the 2 MG mode by delaying a time until the temperature of the power split mechanism 4 reaches the upper limit value in the resumed 2 MG mode. Driving of the MOP 13 with the use of the first motor 2 is not unnecessarily continued, so it is possible to effectively utilize electric power or energy.

### Alternative Embodiments

Each of the above-described embodiments is an example in which the invention is applied to the drive control system for a hybrid vehicle in which the MOP 13 is coupled to the engine 1, so the MOP 13 is driven in the 1 MG mode or the engine 1 is subjected to motoring with the use of the first motor 2 in order to increase the amount of lubricating oil supplied. That is, in each of the above-described embodiments, the amount of lubricating oil that is discharged from the MOP 13 increases by driving the first motor 2 in the 1 MG mode, and the amount of lubricating oil that flies off as a result of rotation of the input shaft 81 (lubricating oil passage 83) increases. In short, the drive control system according to the invention just needs to be configured to increase the amount of lubricating oil supplied in order to cool the power split mechanism 4 or the pinion gears 7 and pinion pins of the power split mechanism 4. Therefore, the amount of lubricating oil that is supplied to the power split mechanism 4 in the 1 MG mode may be increased by any one of control for driving the MOP 13 with the use of the first motor 2 and control for rotating the lubricating oil passage 83 with the use of the first motor 2, instead of the above-described motoring.

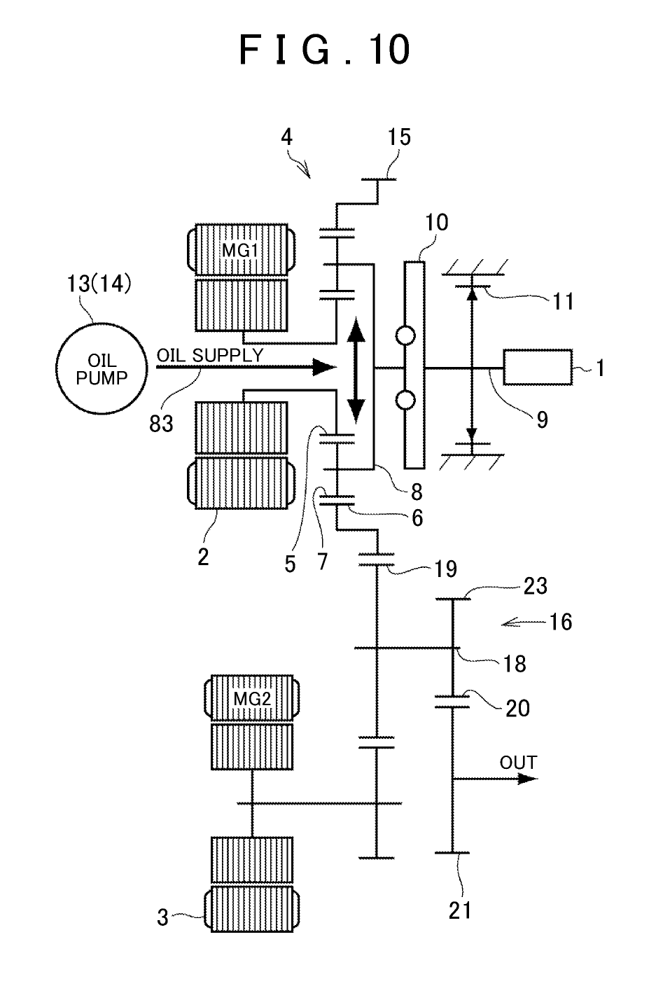

FIG. 10 shows an example configured to increase the amount of lubricating oil by centrifugal force. The lubricating oil passage 83 is provided so as to open at the outer periphery of a sun gear shaft, and is not coupled to the input shaft 81 or the MOP 13. The remaining configuration shown in FIG. 10 is similar to the configuration shown in FIG. 7. When a powertrain is configured as shown in FIG. 10, the drive control system according to the invention, in the 1 MG mode after the 2 MG mode, rotates the lubricating oil passage 83 together with the sun gear shaft with the use of the first motor 2, and increases the amount of lubricating oil that is supplied to the power split mechanism 4 by applying centrifugal force to lubricating oil flowing out from the lubricating oil passage 83.

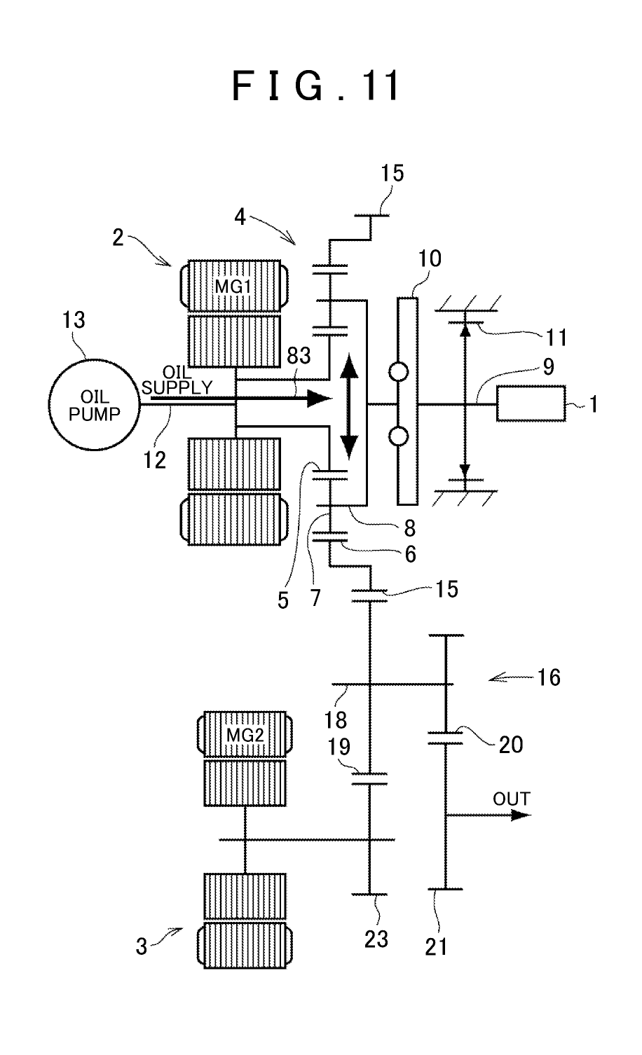

An example shown in FIG. 11 is an example in which the first motor 2 is coupled to the MOP 13 in addition to the above-described configuration shown in FIG. 10. With the above configuration, when the first motor 2 is driven in the 1 MG mode after the 2 MG mode, the lubricating oil passage 83 is rotated and also the MOP 13 is driven, so the amount of lubricating oil that is supplied by the MOP 13 and the amount of lubricating oil that flies off by centrifugal force both are increased.

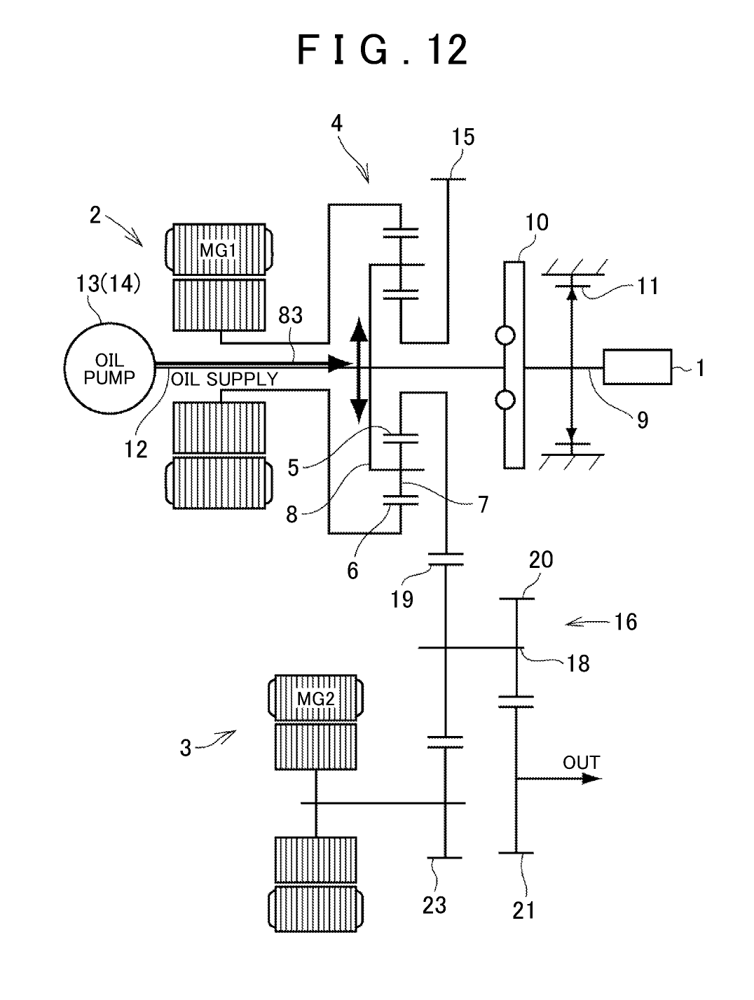

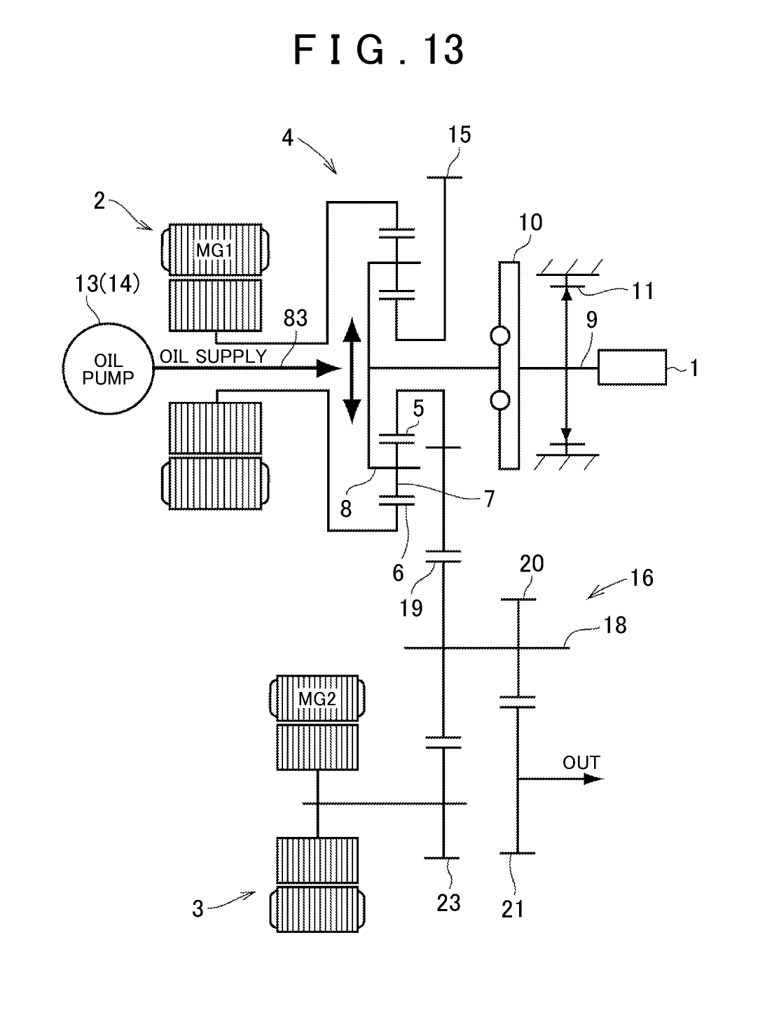

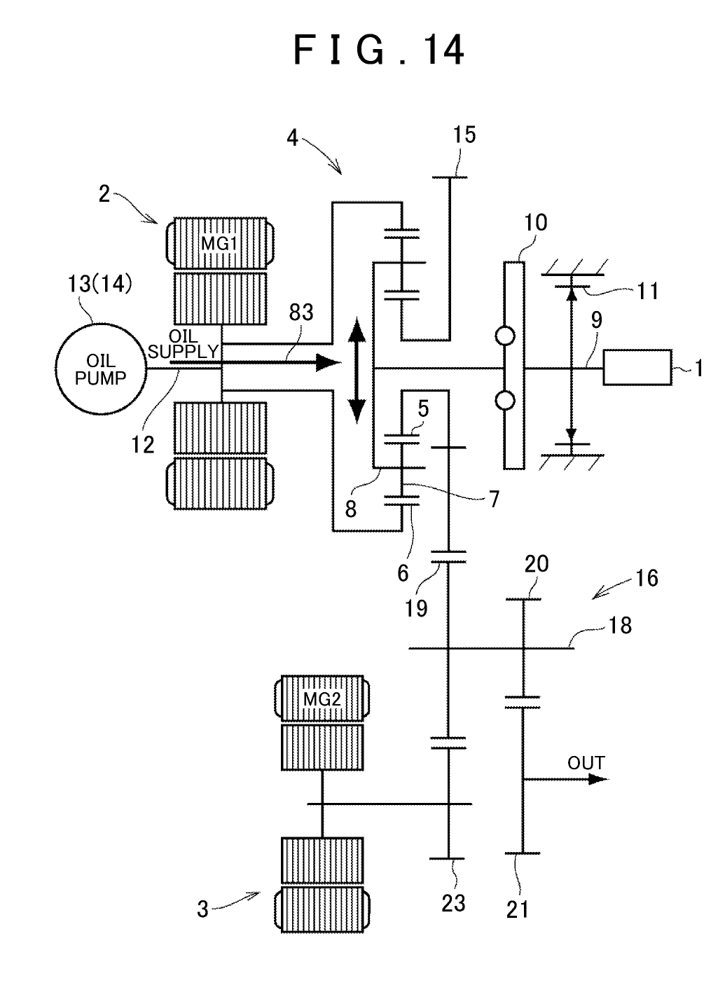

The hybrid vehicle to which the invention is applied may include a powertrain other than the powertrain shown in FIG. 7. FIG. 12 shows an example that is partially modified from the configuration shown in FIG. 7. In the powertrain shown here, the first motor 2 is coupled to the ring gear 6, the output gear 15 is coupled to the sun gear 5, and the remaining configuration is similar to the configuration shown in FIG. 7. FIG. 13 shows an example that is partially modified from the configuration shown in FIG. 10. In the powertrain shown here, the first motor 2 is coupled to the ring gear 6, the output gear 15 is coupled to the sun gear 5, and the remaining configuration is similar to the configuration shown in FIG. 10. FIG. 14 shows an example that is partially modified from the configuration shown in FIG. 11. In the powertrain shown here, the first motor 2 is coupled to the ring gear 6, the output gear 15 is coupled to the sun gear 5, and the remaining configuration is similar to the configuration shown in FIG. 11. Even in the drive control system for a hybrid vehicle including any one of the powertrains shown in FIG. 12 to FIG. 14, by executing control in which “carrying out motoring” is read as “driving the first motor” within the controls shown in FIG. 1 to FIG. 6, it is possible to cool the power split mechanism 4 in just proportion in the 1 MG mode after the 2 MG mode.

The invention is not limited to the above-described embodiments. The invention may be implemented by a combination of the above-described embodiments as needed without any contradiction in control. In the above-described embodiments, the power split mechanism is formed of the single-pinion-type planetary gear mechanism. In the invention, the power split mechanism may be formed of a double-pinion-type planetary gear mechanism.

What is claimed is:

1. A drive control system for a hybrid vehicle, the drive control system characterized by comprising:
an engine;
an output member configured to transmit driving force to a drive wheel;
a first motor;
a power split mechanism configured to distribute and transmit driving force, output from the engine, to the output member and the first motor;
a lubricating oil passage configured to supply lubricating oil to the power split mechanism by causing the lubricating oil to flow outward in a radial direction of the power split mechanism from a rotation center side of the power split mechanism;
a first oil pump configured to be allowed to be driven by the first motor, the first oil pump being configured to generate hydraulic pressure of the lubricating oil that lubricates the power split mechanism;
a second motor configured to be able to output driving force to the drive wheel in a state where the engine and the first motor are not generating driving force; and
an electronic control unit configured to, when the hybrid vehicle is set to a one-motor mode after traveling in a two-motor mode, execute control for increasing an amount of the lubricating oil that is supplied to the power split mechanism by driving the first motor, the one-motor mode being a mode in which the hybrid vehicle is caused to travel by the use of driving force that is output from the second motor, the two-motor mode being a mode in which the hybrid vehicle is caused to travel by the use of driving force that is output from the first motor and the second motor.

2. The drive control system according to claim 1, wherein
the electronic control unit is configured to execute control for increasing the amount of the lubricating oil by driving the first oil pump with the use of the first motor.

3. The drive control system according to claim 1, wherein
the lubricating oil passage is configured to be rotated to cause the lubricating oil to fly off by centrifugal force, and
the electronic control unit is configured to execute control for increasing the amount of the lubricating oil by increasing an amount of the lubricating oil that flies off as a result of rotation of the lubricating oil passage.

4. The drive control system according to claim 2, further comprising:
a second oil pump configured to supply the lubricating oil to the power split mechanism via the lubricating oil passage by generating hydraulic pressure of the lubricating oil, wherein
the electronic control unit is configured to, when the hybrid vehicle is set to the one-motor mode after traveling in the two-motor mode and when the amount of lubricating oil discharged from the second oil pump is larger than or equal to a predetermined threshold, not drive the first oil pump with the use of the first motor.

5. The drive control system according to claim 1, wherein
the electronic control unit is configured to, when the hybrid vehicle is set to the one-motor mode after traveling in the two-motor mode and when a vehicle speed is lower than or equal to a predetermined vehicle speed, execute control for increasing the amount of the lubricating oil by driving the first oil pump with the use of the first motor.

6. The drive control system according to claim 1, further comprising:
an input shaft coupled to an output shaft of the engine, the input shaft being configured to transmit driving force of the engine to the power split mechanism;
a brake mechanism configured to stop rotation of the output shaft or rotation of the input shaft; and
a transmission shaft that couples the input shaft to the first oil pump, wherein
the transmission shaft and the input shaft have the lubricating oil passage, and the input shaft has an opening at its outer periphery,
the lubricating oil passage extends in an axial direction and is coupled to the opening, and
the lubricating oil passage is configured to cause lubricating oil to fly off toward the power split mechanism by rotating the input shaft with the use of the first motor.
